(19) United States
(12) Patent Application Publication
(10) Pub. No.: US 2007/0166089 A1
(43) Pub. Date: Jul. 19, 2007

(54) PAPER DISCHARGING SYSTEM FOR USE WITH AN IMAGE FORMING APPARATUS AND A DISCHARGING METHOD USING THE PAPER DISCHARGING SYSTEM

(75) Inventor: Hang-min Cho, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/622,189

(22) Filed: Jan. 11, 2007

(30) Foreign Application Priority Data
Jan. 17, 2006 (KR) 2006-4880

(51) Int. Cl. B65H 43/00; G03G 15/00

(52) U.S. Cl. 399/405; 271/176

(57) ABSTRACT

A system of an image forming apparatus having a fixing unit at which toner is fixed to a recording medium, including a discharging roller, which conveys the recording medium along a conveying path and which discharges the recording medium from the image forming apparatus after the recording medium passes the fixing unit on the conveying path, an entry detecting sensor, which is disposed at an entry side of the fixing unit such that the fixing unit is between the entry detecting sensor and the discharging roller, to detect the front and rear ends of the recording medium, and an exit detecting sensor, which is disposed at an exit side of the discharging roller such that the discharging roller is between the exit detecting sensor and the fixing unit, to detect the front and rear ends of the recording medium.

### CROSS-REFERENCE TO RELATED APPLICATION

This application claims the benefit of Korean Application No. 2006-4880, filed Jan. 17, 2006 in the Korean Intellectual Property Office, the disclosure of which is incorporated herein by reference.

### BACKGROUND OF THE INVENTION

1. Field of the Invention

Aspects of the present invention relate to a paper discharging system for use with an image forming apparatus, which facilitates discharging of printing paper, and, more particularly, to a paper discharging system having improved jam processing and a paper discharging method using the paper discharging system.

2. Description of the Related Art

In general, electro-photographic image forming apparatuses are structured as shown in FIG. 1 in which a recording medium P (i.e., paper, transparency) stored in a cassette 1 is conveyed along a conveying path in a sheet by sheet sequence. A toner image is coated on one side of the recording medium P by a developing unit 3. The toner image is fixed thereon using an application of heat and pressure by a fixing unit 4. The recording medium P is discharged out of a main frame 10 of the image forming apparatus 10. When printing begins, a pick-up roller 2 along with other rollers operate, and a conveying process begins in which the recording medium P continuously passes along the conveying path in the sheet by sheet sequence. The developing unit 3 and the fixing unit 4 are disposed along the conveying path.

Transfer discharging rollers 6 and exit discharging rollers 7 are disposed along the conveying path to discharge the recording medium P out of the main frame 10.

Sensors S1 and S2 detect whether the recording medium P passes along the conveying path. A controller (not shown) determines whether the recording medium P readily passes along the conveying path. If the recording medium P is being conveyed normally the sensor S1 (hereinafter referred to as an “entry detecting sensor”) disposed in front of the developing unit 3 first detects the front end of the recording medium P. Then, the sensor S2 (hereinafter referred to as an “exit detecting sensor”) disposed between the fixing unit 4 and a discharging roller S detects the front end of the recording medium P. Thereafter, the entry detecting sensor S1 detects the rear end of the recording medium P, and then the exit detecting sensor S2 detects the rear end of the recording medium P.

This can be illustrated as the timing diagram of FIGS. 2A and 2B, showing on/off states of the two sensors S1 and S2 in the recording medium conveying process. If the two sensors S1 and S2 are timely turned on or turned off, the recording medium P is conveyed normally. Otherwise, the recording medium P is conveyed abnormally, causing a paper jam. For example, if the entry detecting sensor S1 detects the front end of the recording medium P, and the exit detecting sensor S2 does not send a signal indicating that the front end of the recording medium P is detected within a predetermined time of Int-1, it is determined that the recording medium P is jammed before passing the exit detecting sensor S2. Thus, a jam signal is generated. In addition, if the exit detecting sensor S2 detects the front end of the recording medium P, and then the exit detecting sensor S2 does not send a signal indicating that the rear end of the recording medium P is detected within a predetermined time of Int-2, it is determined that the recording medium P is jammed between the fixing unit 4 and the discharging roller 5. Thus, the jam signal is generated.

In the case above, if the recording medium P is jammed between the fixing unit 4 and the discharging roller 5, the rear end of the recording medium P is out of the cassette 1, and exists in the conveying path. Thus, if the jam occurs, the recording medium P cannot be pulled out from the cassette 1. For this reason, the recording medium P has to be pulled out through a door (not shown) of the main frame 10. If a portion of at least approximately 20 mm is left in the rear end of the recording medium P, which has entered into the fixing unit 4, the recording medium P may be pulled out of the jam by grabbing the portion. However, if the recording medium P is crumpled while entering into a narrow space between the fixing unit 4 and the discharging roller 5, the fixing unit 4 has to be separated from the main frame 10 first to remove the recording medium P.

Usually, the recording medium P jammed between the fixing unit 4 and the discharging roller 5 is crumpled in a shape of an accordion due to a hot temperature of the fixing unit 4. This is called an accordion jam. This occurs when the rear end of the recording medium P is conveyed before the front end of the recording medium P detected by the exit detecting sensor S2 does not enter into a nip of the discharging roller 5. When the accordion jam occurs, the recording medium P almost enters between the discharging roller 5 and the fixing unit 4, because all rollers operate while the rear end of the recording medium P passes the exit detecting sensor S2. For this reason, whenever the accordion jam occurs, the fixing unit 4 needs to be separated from the main frame 10 to removed the recording medium P. Thus, there needs to be a more convenient method of removing the paper jam.

### SUMMARY OF THE INVENTION

Aspects of the present invention provide an improved recording medium discharging system for use with an image forming apparatus, which prevents an accordion jam, and a recording medium discharging method using the recording medium discharging system.

According to an aspect of the present invention, there is provided a recording medium discharging system of an image forming apparatus, comprising: a discharging roller, which conveys the recording medium along a conveying path and which discharges the recording medium from the image forming apparatus, after the recording medium passes a fixing unit on the conveying path; an entry detecting sensor, which is disposed at the entry side of the fixing unit, to detect the front and rear ends of the recording medium; and an exit detecting sensor, which is disposed at the exit side of the discharging roller, to detect the front and rear ends of the recording medium, wherein a jam signal is generated if the exit detecting sensor does not detect the front end of the recording medium within a predetermined time after the entry detecting sensor detects the rear end of the recording medium.

According to another aspect of the present invention, there is provided a recording medium discharging method for use with an image forming apparatus, comprising: detecting a front end of the recording medium being conveyed through the image forming apparatus by an entry detecting sensor disposed at an entry side of a fixing unit; and after the entry detecting sensor detects a rear end of the recording medium, determining that a normal state is in effect if the front end of the recording medium is detected by a exit detecting sensor disposed at an exit side of the fixing unit within a predetermined time, and determining that a jammed state is in effect if the front end of the recording medium is not detected within the predetermined time.

According to aspects of the invention, the predetermined time may be determined to be a time before the entry detecting sensor detects the rear end of the recording medium, if the length of the recording medium is greater than the distance between the entry detecting sensor and the exit detecting sensor, and the predetermined time may be determined to be a time after the entry detecting sensor detects the rear end of the recording medium, if the length of the recording medium is less than the distance between the entry detecting sensor and the exit detecting sensor.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an internal structure of an image forming apparatus having a conventional recording medium discharging system;

FIGS. 2A and 2B are timing diagrams illustrating on/off states of an entry detecting sensor and an exit detecting sensor included in the recording medium discharging system of FIG. 1, with respect to time;

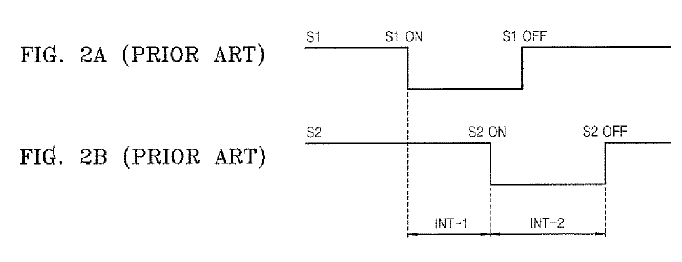

FIG. 3 shows an internal structure of an image forming apparatus having a recording medium discharging system according to an embodiment of the present invention;

FIGS. 4A through 4C are timing diagrams illustrating on/off states of an entry detecting sensor and an exit detecting sensor included in the recording medium discharging system of FIG. 3, with respect to time, according to an embodiment of the present invention;

FIGS. 5A through 5C are timing diagrams illustrating on/off states of an entry detecting sensor and an exit detecting sensor included in the recording medium discharging system of FIG. 3, with respect to time, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

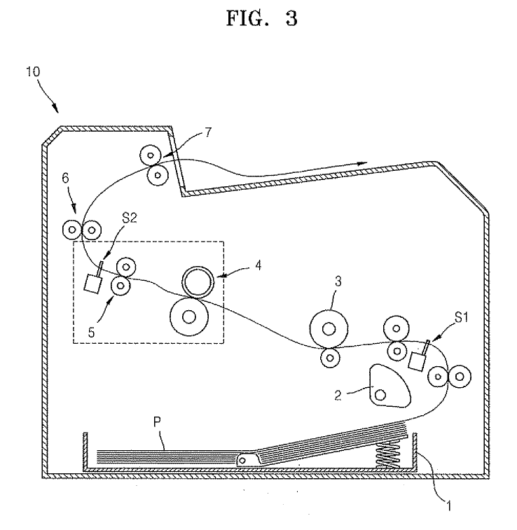

FIG. 3 is a schematic view of a structure of an image forming apparatus having a recording medium discharging system according to an embodiment of the present invention. As shown in FIG. 3, in the image forming apparatus, a sheet of recording media P (i.e., papers, transparencies) in a cassette 1 is picked up by a pick-up roller 2 and passed along a conveying path along which a developing unit 3 and a fixing unit 4 are disposed. An image is printed on one side of the recording medium, and the recording medium P is discharged out of a main frame 10 by a discharging roller 5, and transfer discharging rollers 6 and exit discharging rollers 7, which are disposed along the conveying path.

While shown as a printer, it is understood that the apparatus can be a facsimile machine, a copier, a scanner, in addition to, or instead of a printer

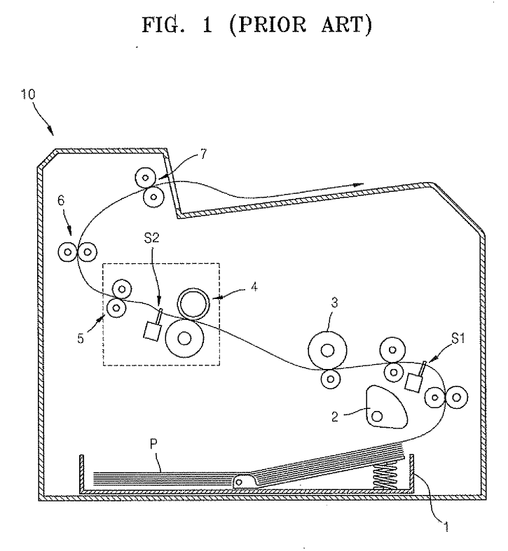

An entry detecting sensor S1 and an exit detecting sensor S2 are provided to facilitate discharging of the recording medium R As in image forming apparatuses of FIG. 1, the entry detecting sensor S1 is disposed in front of the fixing unit 4, and in front of the developing unit 3. The exit detecting sensor S2 is disposed behind of the discharging roller 5 near the fixing unit 4. From the viewpoint of the fixing unit 4 and the discharging roller 5, the entry detecting sensor S1 is disposed at the entry side of the fixing unit 4, and the exit detecting sensor S2 is disposed at the exit side of the discharging roller 5. In comparison, the exit detecting sensor S2 is disposed between the fixing unit 4 and the discharging roller 5. By changing the location of the exit detecting sensor S2, an accordion jam occurring between the discharging roller 5 and the fixing unit 4 can be relatively easily prevented as follows.

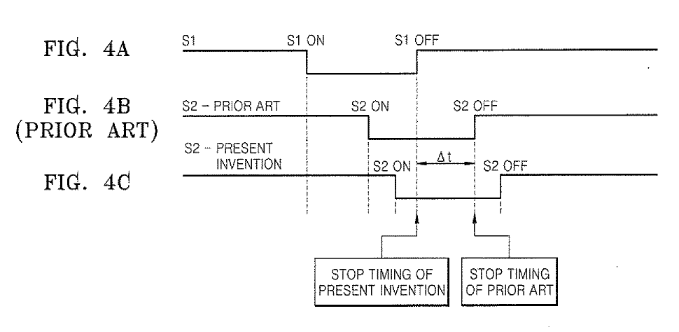

If the recording medium P passes normally along the conveying path of the image forming apparatus shown in FIG. 3, the entry detecting sensor S1 first detects the front end of the recording medium P. Then, the exit detecting sensor S2 disposed at the exit side of the discharging roller 5 detects the front end of the recording medium P. According to an aspect of the present invention, the front end of the recording medium P is detected at a slightly later time than as in image forming apparatuses of FIG. 1, because the exit detecting sensor S2 is moved back along the conveying path. Then, the entry detecting sensor S1 detects the rear end of the recording medium P, and the exit detecting sensor S2 detects the rear end of the recording medium P This is illustrated in the timing diagram of FIGS. 4A through 4C, showing on/off states of the two sensors S1 and S2 in the recording medium conveying process. In the timing diagrams, the conventional image forming apparatuses and an aspect of the present invention are compared.

Assuming that the recording medium P is not conveyed through the nip of the discharging roller 5, and assuming that the accordion jam occurs between the discharging roller 5 and the fixing unit 4 the following situation arises. After the entry detecting sensor S1 detects the front end of the recording medium P, the exit detecting sensor S2 does not generate a detection signal of the recording medium P until the entry detecting sensor S1 detects the rear end of the recording medium P. In this case, the exit detecting sensor S2 cannot detect the recording medium P, because the rear end of the recording medium P is only conveyed while the front end of the recording medium P does not pass the discharging roller 5. Then, a controller (not shown) presumes that the paper jam occurs, generates a jam signal, and stops operations of all of the rollers 3, 5, 6, and 7. As shown in FIGS. 4A through 4C, the time for recognizing the accordion jam and stopping operations of the rollers 3, 5, 6, and 7 in the aspects of the present invention is much faster than as in the image forming apparatuses of FIG. 1.

In the image forming apparatuses of FIG. 1, the accordion jam occurs after the front end of the recording medium P is detected by the exit detecting sensor S2 disposed between the discharging roller 5 and the fixing unit 4. Thus, an abnormal operation is detected after the exit detecting sensor S2 detects the rear end of the recording medium P.

However, in an aspect of the present invention, since the exit detecting sensor S2 is disposed at the exit side of the discharging roller 5, the abnormal operation is immediately detectable if the exit detecting sensor S2 does not generate a detection signal of the front end of the recording medium P until the entry detecting sensor S1 detects the rear end of the recording medium R As a result, the paper jam can be detected, and thus operations of the rollers can be stopped as earlier as by Δt. Therefore, the operations can be stopped before a portion of the rear end of the recording medium P enters into the fixing unit 4.

Usually, if a portion of at least about 20 mm is left in the recording medium P, which is yet entered into the fixing unit 4, a user can grab the portion to pull out the recording medium P. Thus, if the operations can be stopped immediately, the paper jam can be removed without having to separate the fixing unit 4. In an aspect of the present invention, since the paper jam is detected when the rear end of the recording medium P passes the entry detecting sensor S1, a sufficient length is left in the recording medium P, which is not yet entered into the fixing unit 4. Therefore, the paper jam can be easily removed.

As described above, the accordion jam can be recognized faster, and the operations can be stopped faster by moving the location of the exit detecting sensor S2 from the entry side of the discharging roller 5 to the exit side of the discharging roller 5. This makes a significant difference when removing the paper jam.

This embodiment of the present invention has been described for a general case in which the length of the recording medium P is greater than the distance between the entry detecting sensor S1 and the exit detecting sensor S2. However, the length of the recording medium P may be less than the distance between the two sensors S1 and S2 in practice. In this case, detecting the order of the sensors S1 and S2 is different from the explanation above. Since the length of the recording medium P is short, the entry detecting sensor S1 detects the front end of the recording medium P and the rear end of the recording medium P, in this order, and then the exit detecting sensor S2 detects the front end of the recording medium P

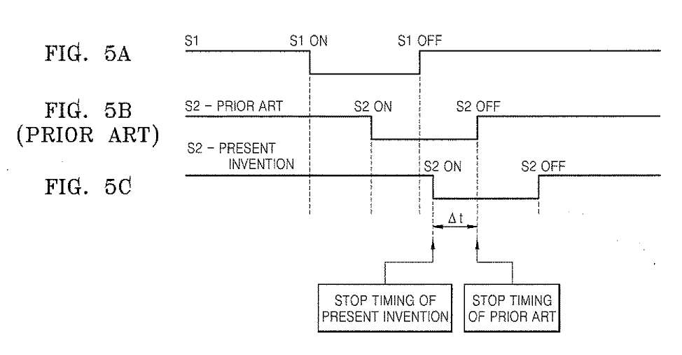

As shown in the timing diagrams of FIGS. 5A through 5C, a time S2 ON becomes later than a time S1 OFF. In this case, the paper jam is recognized if a signal of S2 ON is not received within a predetermine time after a signal of S1 OFF is received, and thus the operations are stopped immediately. The stop timing is later than as in FIGS. 4A through 4C, but is faster than as in the image forming apparatuses of FIG. 1. In the method of recognizing a paper jam according to a image forming apparatus of FIG. 1, the paper jam is recognized based on the timing of OFF signal generated by the exit detecting sensor S2, which is the latest generated signal from among ON/OFF signals of the two sensors S1 and S2, as shown in FIGS. 4B and 4C. However, in the embodiments of the present invention, it is determined whether the entry detecting sensor S1 is ON within a predetermined time which is slight faster or later than the OFF timing of the entry detecting sensor S1, thereby removing the paper jam easily.

The jam recognizing method based on a recording medium size can be implemented by a controller that can switches jam recognizing modes automatically based on the recording medium size.

Accordingly, in a recording medium discharging system and a method thereof according aspects of the present invention, an accordion jam occurring between a fixing unit and a discharging roller may be recognized faster, and, thus, may be immediately removed. Therefore, the paper jam may be removed without having to separate the fixing unit.

While not required in all aspects, it is understood that aspects of the present invention can be implemented as software and/or firmware implemented using a processor or a computer.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A recording medium discharging system of an image forming apparatus having a fixing unit at which toner is fixed to a recording medium, comprising:
a discharging roller, which conveys the recording medium along a conveying path and which discharges the recording medium from the image forming apparatus after the recording medium passes the fixing unit on the conveying path;
an entry detecting sensor, which is disposed at an entry side of the fixing unit such that the fixing unit is between the entry detecting sensor and the discharging roller, to detect the front and rear ends of the recording medium; and
an exit detecting sensor, which is disposed at an exit side of the discharging roller such that the discharging roller is between the exit detecting sensor and the fixing unit, to detect the front and rear ends of the recording medium, wherein a jam signal is generated when the exit detecting sensor does not detect the front end of the recording medium within a predetermined time after the entry detecting sensor detects the rear end of the recording medium.

2. The recording medium discharging system according to claim 1, wherein the predetermined time is a time before the entry detecting sensor detects the rear end of the recording medium, if the length of the recording medium is greater than a distance between the entry detecting sensor and the exit detecting sensor, and wherein the predetermined time is a time after the entry detecting sensor detects the rear end of the recording medium, if the length of the recording medium is less than the distance between the entry detecting sensor and the exit detecting sensor.

3. A recording medium discharging method for use with an image forming apparatus, comprising:
detecting a front end of the recording medium being conveyed through the image forming apparatus by an entry detecting sensor disposed at an entry side of a fixing unit; and
after the entry detecting sensor detects a rear end of the recording medium, determining that a normal state is in effect if the front end of the recording medium is detected by a exit detecting sensor disposed at an exit side of the fixing unit within a predetermined time, and determining that a jammed state is in effect if the front end of the recording medium is not detected within the predetermined time.

4. The recording medium discharging method according to claim 3, wherein the predetermined time is a time before the exit detecting sensor detects a rear end of the recording medium, if the length of the recording medium is greater than a distance between the entry detecting sensor and the exit detecting sensor, and wherein the predetermined time is a time after the entry detecting sensor detects the rear end of the recording medium, if the length of the recording medium is less than the distance between the entry detecting sensor and the exit detecting sensor.

5. A recording medium discharging system of an image forming apparatus having a fixing unit to fix an image on a recording medium, comprising:
a discharging roller, which conveys the recording medium along a conveying path and which discharges the recording medium from the image forming apparatus, after the recording medium passes the fixing unit on the conveying path;
a first sensor, which is disposed upstream of the fixing unit along the conveying path, to detect front and rear ends of the recording medium; and
a second sensor, which is disposed downstream of the discharging roller along the conveying path, to detect the front and rear ends of the recording medium, wherein a signal indicating an existence of a recording medium jam is generated when the second detecting sensor does not detect the front end of the recording medium within a predetermined time after the first detecting sensor detects the rear end of the recording medium.

6. The recording medium discharging system according to claim 5, wherein the predetermined time is a time before the first sensor detects the rear end of the recording medium.

7. The recording medium discharging system according to claim 5, wherein the predetermined time is a time after the first sensor detects the rear end of the recording medium.

8. The recording medium discharging system according to claim 5, further comprising a recording medium cassette to store recording media in a lower portion of the image forming apparatus.

9. The recording medium discharging system according to claim 8, further comprising a pickup roller to pick up the recording medium from the recording medium cassette and to feed the recording medium onto the conveying path.

10. The recording medium discharging system according to claim 5, further comprising a developing unit to develop a latent image on the recording medium, the developing unit being disposed downstream from the pickup roller and upstream from the fixing unit along the conveying path.

11. The recording medium discharging system according to claim 5, further comprising transfer discharging rollers and exit discharging rollers disposed downstream from the discharging roller along the conveying path to discharge the recording medium from the main frame.

12. A recording medium discharging method for use with an image forming apparatus, comprising:
detecting a first end of the recording medium being conveyed along a conveying path through the image forming apparatus by a first sensor disposed upstream of a fixing unit along the conveying path; and
determining that a normal state is in effect if the first end of the recording medium is detected by a second sensor disposed at an exit side of the fixing unit within a predetermined time, and determining that a jammed state is in effect if the first end of the recording medium is not detected within the predetermined time.

13. The recording medium discharging method according to claim 12, wherein the predetermined time is a time before the second sensor detects a second end of the recording medium

14. The recording medium discharging method according to claim 12, wherein the predetermined time is a time after the first sensor detects the second end of the recording medium.
